(19) United States
(12) Patent Application Publication
(10) Pub. No.: US 2018/0089539 A1
(43) Pub. Date: Mar. 29, 2018

(54) Eye-in-hand Visual Inertial Measurement Unit

(71) Applicant: DunAn Precision, Inc., Dallas, TX (US)

(72) Inventors: Hongsheng He, Austin, TX (US); Jian Lu, Dallas, TX (US); Shengchang Zhang, Dallas, TX (US)

(21) Appl. No.: 15/714,059

(22) Filed: Sep. 25, 2017

Related U.S. Application Data
(60) Provisional application No. 62/398,536, filed on Sep. 23, 2016.

(51) Int. Cl. G06K 9/62; H04N 5/225

(52) U.S. Cl. CPC G06K 9/6288; G01P 15/08; H04N 5/2252

(57) ABSTRACT

A visual inertial measurement unit includes: a housing; a computing module associated with the housing and including a central processing unit; a camera module associated with the housing, the camera module including a camera lens and a camera sensor, the camera module in electronic communication with the computing module; an inertial measurement unit module associated with the housing, the inertial measurement unit module including at least one inertial sensor, the inertial measurement unit module in electronic communication with the computing module; and an interface module including one or more output interfaces, the interface module in electronic communication with the computing module. The computing module receives camera data from the camera module and motion data from the inertial measurement unit data. The computing module generates output data, the output data including synchronized camera and motion data.

### CROSS-REFERENCE TO RELATED APPLICATIONS

This application claims priority to U.S. provisional patent application Ser. No. 62/398,536 for an “Eye-in-hand Visual Inertial Measurement Unit” filed on Sep. 23, 2016, the contents of which are incorporated herein by reference in its entirety.

### FIELD

This disclosure relates to the field of sensors. More particularly, this disclosure relates to sensors for measuring and processing in real-time visual and inertial measurements.

### BACKGROUND

Industrial equipment frequently relies on a variety of sensors during operation. For example, visual and inertial sensors may be separately used in industrial automation, robotics, unmanned aerial vehicles (“UAV”), and other unmanned vehicles (“UMVs”). Visual sensors operating alone enable precise long-term tracking of objects, but estimation accuracy is often impaired by unpredicted abrupt motion and other factors. Inertial sensors are robust to external conditions yet often impaired by drifts over time due to accumulated integration errors.

While attempts have been made to utilize at least two types of sensors, those efforts require a complex installation process and procedures and tedious relative sensor calibration, data synchronization, and communication. Further, requirements related to processing and fusion of measurements from the sensors are typically performed remotely, thereby making it difficult to achieve high-throughput processing and synchronization. To overcome these problems, a dedicated high-performance computer equipped with a powerful GPU may be required to achieve real-time processing.

What is needed, therefore, is an eye-in-hand visual inertial measurement unit for capturing visual and inertial data and synchronizing measurements in real-time.

### BRIEF DESCRIPTION OF THE DRAWINGS

The above and other needs are met by a visual inertial measurement unit. In a first aspect, a visual inertial measurement unit includes: a housing; a computing module associated with the housing and including a central processing unit; a camera module associated with the housing, the camera module including a camera lens and a camera sensor, the camera module in electronic communication with the computing module; an inertial measurement unit module associated with the housing, the inertial measurement unit module including at least one inertial sensor, the inertial measurement unit module in electronic communication with the computing module; an interface module including one or more output interfaces, the interface module in electronic communication with the computing module. The computing module receives camera data from the camera module and motion data from the inertial measurement unit data. The computing module generates output data, the output data including synchronized camera and motion data.

In one embodiment, the housing further comprising an extension portion extending from the housing, the extension portion including a camera lens formed therein.

In another embodiment, each of the computing module, camera module, inertial measurement unit, and interface module is substantially interchangeable on the housing.

In yet another embodiment, the computing module is configured to determine one of image flow features, motion estimation, and depth estimation locally on the visual inertial measurement unit based on data received from the camera module and inertial measurement unit module.

In one embodiment, the computing module is further configured to output the determined image flow features, motion estimation, and depth estimation to an off-board processor for further analysis.

In another embodiment, the housing is mounted on a host device, and wherein the computing module is in electronic communication with one or more processors of the host device through the interface module.

In a second aspect, a method of capturing image and motion data on a host device includes: providing a housing mounted on the host device; providing a computing module associated with the housing, the computing module including at least one central processing unit; providing a camera module associated with the housing, the camera module in electronic communication with the computing module; providing an inertial measurement unit module that is associated with the housing, the inertial measurement unit including at least one inertial sensor and in electronic communication with the computing module; an interface module including one or more output interfaces, the interface module in electronic communication with the computing module; receiving image data on the computing module from the camera module; receiving motion data on the computing module from the inertial measurement unit module; synchronizing image and motion data on the computing module; and outputting synchronized image and motion data from the computing module to the host device through the interface module.

In one embodiment, the method further includes processing received image and motion data to determine one of image flow features, motion estimation, and depth estimation on the computing module.

In another embodiment, the method further includes storing the determined one of image flow features, motion estimation, and depth estimation in a format that is compatible with the host device.

In yet another embodiment, the method further includes processing data from the computing module on a processor of the host device.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

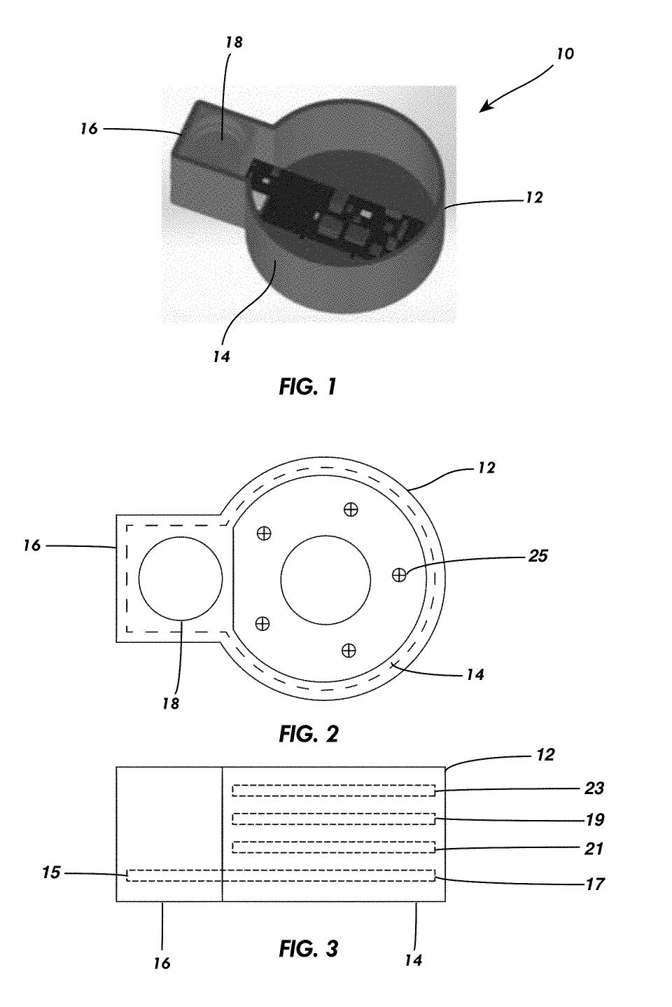

FIG. 1 shows a visual inertial measurement unit and housing according to one embodiment of the present disclosure;

FIG. 2 shows a top view of a visual inertial measurement unit according to one embodiment of the present disclosure;

FIG. 3 shows a cross-sectional side view of a visual inertial measurement unit according to one embodiment of the present disclosure;

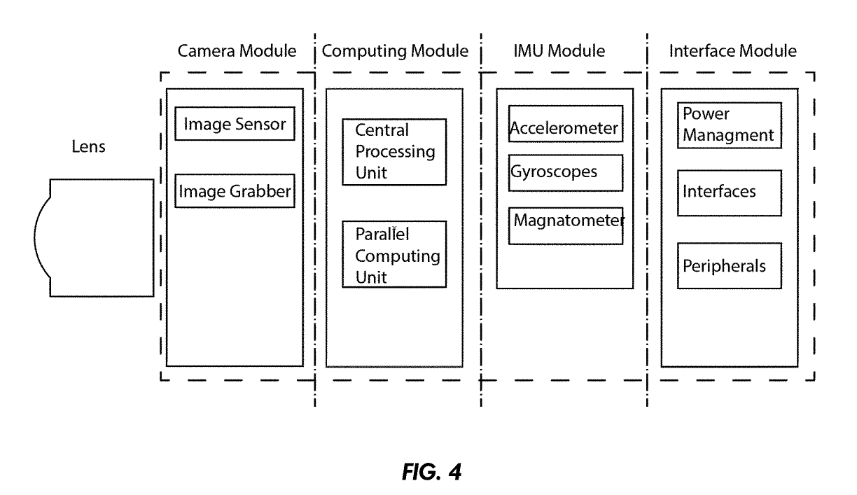

FIG. 4 shows a block diagram of a visual inertial measurement unit according to one embodiment of the present disclosure;

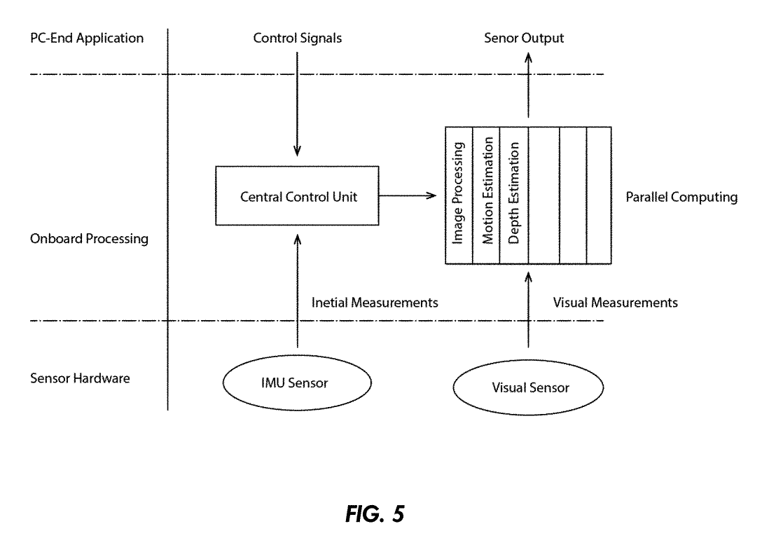

FIG. 5 shows a schematic diagram of data flow and processing of a visual inertial measurement unit according to one embodiment of the present disclosure;

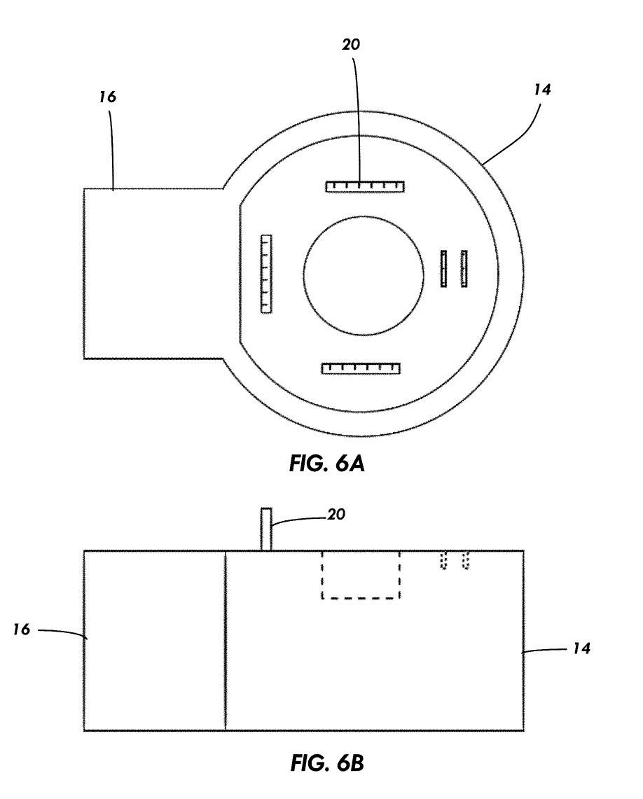

FIGS. 6A and 6B show a housing and interfaces of a visual inertial measurement unit according to one embodiment of the present disclosure;

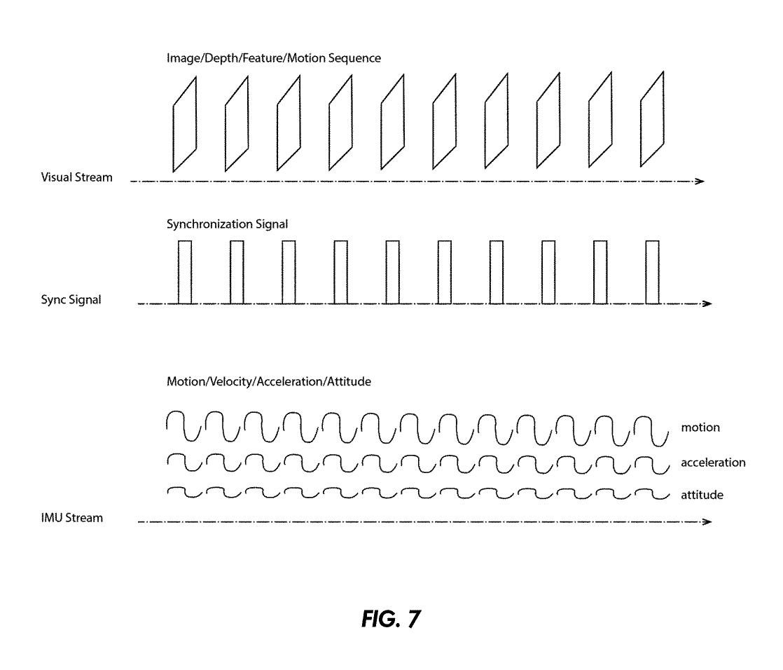

FIG. 7 shows a schematic diagram of data formatting and communication protocol of a visual inertial measurement unit according to one embodiment of the present disclosure; and

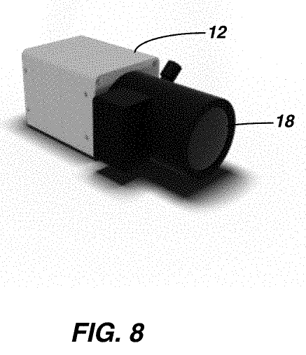

FIG. 8 shows a visual inertial measurement unit according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

FIG. 1 shows a basic embodiment of an eye-in-hand visual inertial measurement unit 10. The visual inertial unit 10 is substantially compact and self-contained within a modular housing and includes standard or common interfaces or connectors such that the visual inertial unit 10 is readily adapted to existing systems. The visual inertial unit 10 provides real-time local processing of visual and inertial data and outputs processed results and data to a host system. Onboard processing includes inertial measurement unit (“IMU”) assisted feature extraction and tracking, segmentation, depth reconstruction, motion management, and visual-inertial heading reference, as well as image processing such as convolution, FFT, and Hough transform.

The eye-in-hand visual inertial measurement unit 10 is substantially standalone such that the unit may directly output shape detection and segmentation in industrial applications, such as pin picking, part assembly, and robotic eye-in-hand vision. The visual-inertial measurement unit 10 may further provide additional functions by fusing visual-inertial sensors and parallel computing on the device. Electronic components of the visual inertial unit 10 are designed to be modular and exchangeable such that the unit may be customized for particular applications.

Referring to FIGS. 1-3, the eye-in-hand visual inertial unit 10 includes a housing 12 adapted to fit with existing systems, such as a robotic arm and other like systems. The housing 12 includes a hollow body portion 14 and an extension portion 16 formed on a side of the body portion 14. The hollow body portion 14 is preferably substantially circular in shape and has a shape and diameter that substantially conforms with a size and shape of a robotic arm to which the visual inertial unit 10 is attached as an extension of the robotic arm.

The housing 12 is preferably formed of a lightweight yet strong material, such as a metal, polymer, or composite material. The housing 12 is configured to accept various electronic components 13 of the visual inertial unit 10 within the housing, including a camera 15 and camera module 17, inertial measurement unit module 19, computing module 21, interface module 23, and any necessary peripherals. The housing 12 further includes various bores 25 or other mounts that enable the visual inertial unit 10 to be attached to various robotic arm interfaces. The camera 15 is positioned within the extension portion 16 such that a view of the camera 15 is towards an end of the robotic arm to which the visual inertial unit 10 is attached. A camera lens 18 is attached to the extension portion 16 to substantially protect a camera within the housing 12. A connection interface 20 (FIGS. 6A and 6B) may further be attached to the housing 12 to communicate internal components of the visual inertial unit with components of the system to which the unit is attached, such connection interface being formed of one or more connection interfaces known in the art, for example, CAN-Bus, USB3.0, and GigE.

The body portion 14 of the housing 12 is preferably circular in shape to conform to a shape of an arm of a robot or other device to which the visual inertial unit 10 is attached. The bores 25 are preferably formed concentrically around a center of the body portion 14 of the housing 12, and are aligned with bores of adjacent portions of a robot arm for securing the housing 12 to a robot arm. While the body portion 14 is preferably circular, it is also understood that the body portion may be formed in various other suitable shapes, such as rectangular.

In one embodiment, various modular components are installed within body portion 14 of the housing 12. The modular components may be located entirely within the housing 12 such that when components are swapped as described herein, those modular components are removed from the housing. In another embodiment, as shown in FIG. 8, each of the modular components may together form the housing 12. The modular components may each include an outer surface that, when joined with other modular components, form the housing 12.

Referring now to FIG. 4, the visual inertial unit 10 includes a plurality of modules including the camera module 17, inertial measurement unit (“IMU”) module 19, the computing module 21, and an interface module 23. The visual inertial unit 10 is configured to capture images through the camera module 17 and data from the IMU module and output processed data to a host device via the interface module 23.

Each of the plurality of modules is modular in that the modules are self-contained and may be installed or swapped independently of other modules based on a desired application or environment in which the visual inertial unit 10 is to be operated. The modules may be sized such that the modules fit within the housing 12 or onto existing spaces of a circuit board or other components within the housing 12. The modules may be connected to a circuit board or other components within the housing 12 using a standard interface, such as USB, Can-Bus, or other like connectors. Connectors of the modules may be substantially symmetrical such that the modules may be placed within the housing 12 in varying order. The modules may further be fixed to a circuit board or connector of the visual inertial unit 10 to prevent inadvertent removal of a module.

With continued reference to FIG. 4, the camera module 17 includes an imaging sensor, CCD/CMOS, and an image capturing circuit for capturing videos or images and outputting a digital signal of the image. The camera module 17 is in electronic communication with the computing module 21, such as with a high-speed bus. The camera module 17 may include any number of available image/camera sensors such as devices configured to capture digital images. The camera module may include an optional dedicated lens if the camera module includes an integrated camera lens and imaging sensors. The imaging sensor is independent of the lens if the camera module is configured to capture digital images or videos.

The camera module 17 may include a hardware or software synchronization mechanism that enables an external signal or a software command to trigger capture of an image at a specific time. When the camera module 17 receives a trigger or command signal, the camera module 17 captures a full image or a sequence of images and transmit capture data to the computing modul 21.

The computing module 21 includes a central processing unit and parallel computing unit and controls processing logics by a micro control unit (“MCU”), such as ARM or DSP. The central processing unit handles interrupts, process scheduling, hardware management, and other capabilities. User commands are parsed and tasks are schedule to respond in the central processing unit.

The central processing unit also performs sequential processing of measurements from the IMU. The IMU measurements are rectified to compensate for sensor distortion and filtered to reduce measurement noise.

Heading reference algorithms, such as complementary and Kalman filters, may be implemented on the central processing unit. An algorithm outputs an attitude of the device by fusing measured rotational velocities, acceleration, and geomagnetism. The central processing unit outputs filtered inertial measurements, computed dynamics variables, and control signals to the parallel computing unit. The central processing unit may control a timing and tasks of the parallel computing unit.

The parallel computing unit includes a graphics processing unit and/or filed-programmable gate array (FPGA). The parallel computing unit implements real-time information processing. Kernel onboard processing algorithms are implemented in the parallel computing unit. The parallel computing unit receives sensor measurements and outputs intermediate or final processing results. Logics of the parallel computing unit are monitored and controlled by the central processing unit.

The IMU includes a set of sensors, including one or more accelerometers, gyroscopes, and magnetometers. The IMU module measures an attitude and dynamics of the visual inertial unit 10. Measured physical data of the unit include an attitude in space, acceleration, rotational velocities, geomagnetism, pressure, and other various parameters. The IMU receives control signals from the central processing unit and outputs computed physical measurements in real-time.

The interface module connects the visual inertial unit 10 to a host device or platform through a standard or customizable interface. The interface module is interchangeable for different interfaces of the hose device, such as CAN-Bus, USB 3.0, GigE, and Ethernet.

The interface module includes a management unit including power management units, communication units, electromagnetic protection units, and other various peripherals.

The camera module and IMU module are synchronized in time through hardware implementation. The capture of images and measurement of dynamics may be initialized at specific sampling times.

FIG. 5 shows a schematic diagram of data flow and processing in the device in accordance with one embodiment of the disclosure. Software executable on the visual inertial unit 10 includes low-level onboard processing, high-level onboard processing, and PC-end computing. The low-level onboard processing outputs intermediate processed results of sensors of the unit without fusion of the data. Low-level processing may include, for example, image processing, video processing, visual feature detection, visual feature tracking, line/shape detection, Hough transform, and FFT transform. These functions are provided to end users by one or more API libraries.

High-level onboard processing outputs processing results of onboard sensors of the visual inertial unit 10. High-level onboard processing may include, for example, device motion tracking, device attitude measurement, object motion estimation, and depth estimation. These functions are provided to end users by one or more API libraries.

PC-end computing utilizes an output of the visual inertial sensor for more complex tasks, such as object detection, reconstruction, and object tracking. PC-end computing also provides device management functions, such as data recording, data replay, device management, synchronization, and real-time visualization.

As shown in FIGS. 6A and 6B, various interfaces 20 may be included on the housing 12 of the visual inertial unit 10 that are common to robotic and industrial applications, such as USB, Ethernet, CAN-Bus, and GPIO. The interfaces may be in communication with the interface module for power supply, control signals, and sensor data.

Referring now to FIG. 7, processing results of the camera module and IMU module are transferred in a synchronized format, in raw data or compress-data form.

The visual inertial measurement unit of the present disclosure advantageously combines an image sensing component with a motion sensing component to provide information to an attached device, such as a robotic arm or other industrial equipment, related to both a field of view and movement of the device. The combined visual and movement data enable the device to track objects within a field of view of the device. The visual and movement data are combined on the visual inertial measurement unit and provided to a computing system onboard the device. This allows the visual inertial measurement unit to be readily installed on an existing device and incorporated into one or more computers of the existing device.

Further, the visual inertial measurement unit of the present disclosure is configured to interface with a host device, such as a robotic device or unmanned aerial vehicle (UAV), and communicate with one or more onboard processors of the host device. The visual inertial measurement unit may communicate with the onboard processors of the host device and output synchronized image and motion data to the onboard processors of the host device for further processing.

In one embodiment, an eye-in-hand device includes: an imaging module comprising an imaging sensor, imaging data grabbing circuits and optical lens; an inertial-measurement unit (IMU) module comprising gyroscopes, accelerometers, and magnetometers; a computing module comprising a central processing unit and a parallel computing unit; an interface module providing standard industrial interfaces; onboard processing method that output real-time visual-inertial information processing using embedded algorithms in the computing module; and a plug-and-play modular hosting case. In another embodiment, the electronics boards inclues a modular design that enables customized building of the device with exchangeable boards as per the requirements of different applications.

In one embodiment, an eye-in-hand device includes a computing module having: a central processing unit controlling the processing logics of the device by a micro-control-unit (MCU) by handling interrupts, scheduling processes, managing hardware, and responding to user requests; and a parallel computing unit that is able to process multiple-dimensional data, achieving real-time information processing by graphics-processing-unit (GPU) and/or field-programmable gate array (FPGA). The eye-in-hand device may include connectors between the device and the hosting platform through standard or customized interfaces, with the support to industrial interfaces including but not limited to CAN-Bus, USB, GigE, and Ethernet and power management units that provides power to the device and protects the electronic boards. Onboard processing methods may include: inertial processing means for the measurement of acceleration, rotational velocities, linear velocities, geomagnetism, and attitude; visual processing means for image processing, image manipulation, and image transformation; and fused visual-inertial processing means for device motion tracking, object movement measurement, depth estimation, and enhanced image processing. In one embodiment, the inertial processing means take the output of accelerometer, gyroscopes, and magnetometers, perform filtering of sensor measurements, and compute velocities and attitude using EKF or complimentary filters. In another embodiment, the visual processing means takes images or video from the imaging module and performs intelligent processing onboard algorithms as required by the application. In one embodiment, the fused visual-inertial processing means combines the measurements of visual and inertial sensors, performs advanced computing algorithms to provide novel functions that neither the inertial sensors nor visual sensors can provide alone, and to provide functions with better performance in terms of accuracy and speed.

In one embodiment, an eye-in-hand device includes a plug-and-play modular hosting case having standard hardware interfaces compatible with robotic platforms, and plug-and-play electronic interfaces. In another embodiment, data is formatted in a data format that transfers the multimodal sensor data described above with strict time synchronization.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A visual inertial measurement unit comprising:
a housing;
a computing module associated with the housing and including a central processing unit;
a camera module associated with the housing, the camera module including a camera lens and a camera sensor, the camera module in electronic communication with the computing module;
an inertial measurement unit module associated with the housing, the inertial measurement unit module including at least one inertial sensor, the inertial measurement unit module in electronic communication with the computing module;
an interface module including one or more output interfaces, the interface module in electronic communication with the computing module;
wherein the computing module receives camera data from the camera module and motion data from the inertial measurement unit data; and
wherein the computing module generates output data, the output data including synchronized camera and motion data.

2. The visual inertial measurement unit of claim 1, the housing further comprising an extension portion extending from the housing, the extension portion including a camera lens formed therein.

3. The visual inertial measurement unit of claim 1, wherein each of the computing module, camera module, inertial measurement unit, and interface module is substantially interchangeable on the housing.

4. The visual inertial measurement unit of claim 1, the computing module configured to determine one of image flow features, motion estimation, and depth estimation locally on the visual inertial measurement unit based on data received from the camera module and inertial measurement unit module.

5. The visual inertial measurement unit of claim 4, the computing module further configured to output the determined image flow features, motion estimation, and depth estimation to an off-board processor for further analysis.

6. The visual inertial measurement unit of claim 1, wherein the housing is mounted on a host device, and wherein the computing module is in electronic communication with one or more processors of the host device through the interface module.

7. A method of capturing image and motion data on a host device, the method comprising:
providing a housing mounted on the host device;
providing a computing module associated with the housing, the computing module including at least one central processing unit;
providing a camera module associated with the housing, the camera module in electronic communication with the computing module;
providing an inertial measurement unit module that is associated with the housing, the inertial measurement unit including at least one inertial sensor and in electronic communication with the computing module;
an interface module including one or more output interfaces, the interface module in electronic communication with the computing module;
receiving image data on the computing module from the camera module;
receiving motion data on the computing module from the inertial measurement unit module;
synchronizing image and motion data on the computing module; and
outputting synchronized image and motion data from the computing module to the host device through the interface module.

8. The method of claim 7, further comprising processing received image and motion data to determine one of image flow features, motion estimation, and depth estimation on the computing module.

9. The method of claim 7, further comprising storing the determined one of image flow features, motion estimation, and depth estimation in a format that is compatible with the host device.

10. The method of claim 7, further comprising further processing data from the computing module on a processor of the host device.
